(19) United States
(12) Patent Application Publication
(10) Pub. No.: US 2026/0043288 A1
(43) Pub. Date: Feb. 12, 2026

(54) POCKET DOOR WITH POWER ASSISTANCE MECHANISM

(71) Applicant: Accuride International GmbH, Diez (DE)

(72) Inventor: Morsli BENSIAMEUR, Northhampton (GB)

(21) Appl. No.: 19/265,696

(22) Filed: Jul. 10, 2025

(30) Foreign Application Priority Data
Aug. 8, 2024 (EP) 24193529.5

(51) Int. Cl. E05F 15/643; E06B 3/46

(52) U.S. Cl. CPC E05F 15/643; E06B 3/4654; E05Y 2201/64; E05Y 2201/668; E05Y 2201/684; E05Y 2201/688; E05Y 2900/14

(57) ABSTRACT

A pocket door including a door panel and a guide arrangement. The guide arrangement includes upper and lower guide rails, upper and lower carriages being mounted in a fixed connection on the door panel at different vertical heights for engagement with the upper and lower guide rails and being designed and provided for suspension and longitudinal motion of the door panel along the upper and lower guide rails between a retracted endposition and an extended end-position, a synchronization system for the synchronization of the motion of the upper and lower carriages along the guide rails, the synchronization system including first and second synchronization cables and at least two deflection rollers being mounted in a fixed connection to the upper and lower carriages, a power support arrangement for supporting or effecting the motion of the pocket door including a pull-cable and a drive exerting a pulling force on the pull-cable.

### TECHNICAL FIELD

The present invention relates to a pocket door and specifically an improved mechanism for power supported movement of the pocket door.

### BACKGROUND OF THE INVENTION

A pocket door is a type of door that slides or can be pushed into a pocket or cavity between two walls or panels when open or during the opening process. The pocket can extend parallel to the plane of the door panel, when the door is in a closed state, so that the door slides into the pocket and disappears into it during the opening process when it is moved linearly like a conventional sliding door during opening. In other variants of pocket doors, the pocket extends perpendicular to the plane of the door panel, when the door is in a closed state, and on the side of the compartment, which is closed by the door. Such pocket doors are first opened like a conventional swing door and then, when the door panel stands perpendicular to the plane of the door panel in the closed state or parallel to the extension of the pocket, pushed into the pocket or pulled into the pocket with powered support.

Pocket doors are particularly useful in places or areas where traditional swing doors might not be practical, where-space saving is a priority or where the door panel should disappear for esthetical reasons, such as in room dividers in living areas.

The pocket door is usually suspended by guide rail elements via moving members or carriages, which are generally attached near the top of the door, but additional moving members or carriages are often also attached near the bottom of the door, particularly in guide arrangements for large and heavy pocket doors. The guide rail elements are laterally mounted inside the pocket to facilitate the sliding retraction of the door into the pocket.

Power-supported guide arrangements for supporting, facilitating or even completely effecting the sliding of the pocket door into or out of the pocket are especially useful to handle and operate large and heavy pocket doors. To address potential tilting or misalignment issues of large and heavy pocket doors equipped with upper and lower carriages mounted respectively to the top and the bottom of the door, known guide arrangements incorporate synchronization systems. These systems ensure coordinated movement and alignment of the upper and lower carriages suspended on the respective upper and lower guide rails when the door slides into or out of the pocket. The synchronization systems ensure that the upper and lower carriages move the same distance in horizontal direction along the guide rails and prevent any carriage from lagging or leading, thus facilitating smooth operation of the door, when the door is pushed into or pulled out of the pocket.

Known solutions of synchronization systems, for example those disclosed in WO 2023/232440 A1, EP 4 286 633 A1 and EP 4 286 631 A1, employ synchronization cables that run from the upper sliding mechanism to the lower sliding mechanism via rollers. These cables ensure the coordinated movement of the upper and lower carriages during movement of the pocket door. Each of the two synchronization cables is fastened at or near the inner end of the upper and lower guide rails within the pocket, or at or near the inner back wall of the pocket. Each synchronization cable is then guided to a deflection roller mounted in a fixed relation to the respective upper or lower carriage, deflected and guided to another deflection roller mounted in a fixed relation to the other carriage, i. e. the lower or upper carriage, respectively, further deflected in a direction towards the outer end of the guide rails, and is then directly or through a mount attached to the pocket door. On the path from the upper deflection roller to the lower deflection roller, and vise versa, the synchronization cables cross in a scissor-like manner.

When the pocket door slides into or out of the pocket, and if there should be a higher pushing or pulling force between the upper and lower region of the door, the synchronization system guarantees that neither carriage leads nor lags behind the other.

Known power supports of guide arrangements for supporting or even completely effecting the sliding of the pocket door into or out of the pocket include mechanisms exerting a pulling-force to push the door out of the pocket or pull the door into the pocket.

WO 2023/232440 A1, EP 4 286 633 A1 and EP 4 286 631 A1 disclose a power support mechanism featuring a pulling-force transmission to provide automatic or at least power supported movement of the door out of the pocket. The pulling-force transmission uses a power spring system with a spring-loaded cable pulley in a housing mounted to at least the upper carriage on the door. A pull-cable is drawn into the housing and wound around the cable pulley through the force exerted by a spring, and the spring is loaded by pulling the pull-cable out of the housing and unwinding it from the cable pulley, when the door is pulled into the pocket.

The loose end of the pull-cable is attached or hooked to a stationary holding element mounted to the pocket wall or to the guide rail on the pocket wall at a position near the end of movement of the door into or out of the pocket. Thus, when the door reaches an end-position distant to the holding element attached to the end of the pull-cable, the spring is tensioned and primed to supply power to pull the door into or out of the pocket towards the opposite end-position.

The trajectory of the pull-cable from the cable pulley to the holding element extends in horizontal direction, i.e. parallel to the guide rails for suspension of the door.

A disadvantage of this system is that adjustment of the power support in respect of force and speed to pull the door into or out of the pocket is limited and requires adjustment of the spring force at the cable pulley within the housing. Also, once mounted, adjustment of the pulling distance of the power support system is impossible or at least complex. Furthermore, once mounted, the direction of the power support, i. e. whether the systems provides power support to pull the door into or out of the pocket, can not be changed or at least requires complex re-installation work. Furthermore, power support can only be provided for one direction of movement, i. e., either for movement into or for movement out of the pocket.

### OBJECT OF THE INVENTION

Therefore, it was an object of the present invention to provide an improved mechanism for power supported movement of a pocket door that overcomes at least some of the disadvantages of the prior art and is less complex and/or requires fewer components.

### DESCRIPTION OF THE INVENTION

This and other objects are solved by a pocket door comprising a door panel and a guide arrangement provided for the suspension and longitudinal motion of the door panel,
wherein the guide arrangement comprises
   an upper guide rail and a lower guide rail, each being mounted or provided to be mounted to a wall or panel of a pocket or compartment at different vertical heights,
   an upper carriage and a lower carriage being mounted in a fixed connection on the door panel t different vertical heights for engagement with the upper and lower guide rails and being designed and provided for suspension and longitudinal motion of the door panel along the upper and lower guide rails between a retracted end-position and an extended end-position,
   a synchronization system for the synchronization of the motion of the upper and lower carriages along the guide rails, the synchronization system comprising first and second synchronization cables and at least two deflection rollers being mounted in a fixed connection to the upper and lower carriages,
   wherein the first synchronization cable extends from a hooking point, which is located at or beyond the retracted end-position with respect to the direction of motion from the extended end position to the retracted end position, to a deflection roller, which is in a fixed connection with the upper carriage, is then deflected at the deflection roller and extends further to another deflection roller, which is in a fixed connection with the lower carriage, is then deflected at the deflection roller and extends further to a hooking point, which is at or beyond the extended end-position with respect to the direction of motion from the retracted end position to the extended end position,
   wherein the second synchronization cable extends from a hooking point, which is located at or beyond the retracted end-position with respect to the direction of motion from the extended end position to the retracted end position, to a deflection roller, which is in a fixed connection with the lower carriage, is then deflected at the deflection roller and extends further to another deflection roller, which is in a fixed connection with the upper carriage, is then deflected at the deflection roller and extends further to a hooking point, which is at or beyond the extended end-position with respect to the direction of motion from the retracted end position to the extended end position,
   a power support arrangement for supporting or effecting the motion of the pocket door comprising a pull-cable and a drive means exerting a pulling force on the pull-cable, wherein the drive means comprises a power means selected from a spring and an electric motor,
   wherein the pull-cable is attached to one of the first or second synchronization cables.

A pull-cable in the sense of the present invention may be any cable, string, cord or wire suitable to be used for the purposes of the present invention. In embodiments of the present invention, a pull-cable in the sense of the present invention is a wire, a strand or a cable braided or twisted from several filaments, such as metal filaments. In further embodiments of the present invention, a pull-cable may suitably also be a chain, a gear chain or a toothed wheel chain, for example, if the pull-cable is provided to be driven by means of a gear wheel or toothed wheel.

Herein, the terminology describing that a component is “mounted in a fixed connection to” another component means that the two components are mounted in a fixed and rigid relation or position to each other, such that the relative positioning of the components is fixed and remains fixed upon displacement of one of the components. These components may be directly affixed to each other or may be connected via other means maintaining their relative positions to each other. For example, a deflection roller being mounted in a fixed connection to a carriage means that the deflection roller is either directly mounted to the carriage or is mounted to the carriage through a fixing fitting, fastening element or other means. If the carriage is mounted to the door panel, the deflection roller may be mounted to the door panel as well to any other member, which is mounted in a fixed relation to the door panel.

In an embodiment of the pocket door of the invention, the upper and lower carriages are mounted on the door panel in vertical alignment to each other. On a typically rectangular door panel, this alignment signifies that the carriages are arranged at the same distance from the door panel's vertical front edge facing towards the pocket exit or from the door panel's vertical back edge facing into the pocket or towards the pockets inner back wall, respectively. At the same time, the upper and lower guide rails are preferably also in vertical alignment to each other. If the guide rails have the same lengths, which is preferably the case, the upper and lower carriages have the same distance to the ends of the upper and lower guide rails.

In an alternative embodiment, upper and lower carriages are mounted on the door panel in misalignment to each other with respect to the vertical. In this case, the upper and lower guide rails may also be in vertical misalignment to each other, such as by the same displacement as the upper and lower carriages.

In an embodiment of the pocket door of the invention, the pull-cable is attached to at least the first or second synchronization cable by a clamp or hook at a distance from the drive means in a region of the respective first or second synchronization cable extending between the deflection roller, which is in a fixed connection with the upper carriage, and the deflection roller, which is in a fixed connection with the lower carriage.

The region of the respective first or second synchronization cables extending between the deflection rollers, which are in a fixed connection with the upper and lower carriages, extends from the upper to the lower regions of the door panel. In this region sections of both the first and second synchronization cables extend, and attachment of the pull-cable to one of the first or second synchronization cables in this region allows to simply change the attachment of the pull-cable from the first to the second synchronization cable, and vice versa, to change the direction of power support, i. e. from power support for the motion of the door panel into the pocket to power support for the motion of the door panel out of the pocket, and vice versa.

In an alternative embodiment, the pull-cable may also be attached to one of the first or second synchronization cables in a region between one of the deflection rollers and the hooking point, where the respective synchronization cable is in fixed connection to the pocket or to the door panel. However, this arrangement would not allow an as simple change of the attachment of the pull-cable from one the other of the first or second synchronization cables, since between a deflection roller and a hooking point, as described, only one of the synchronization cables extends. Therefore, this embodiment may be suitable for pocket doors, wherein the power support shall rather be maintained for only one direction, i. e. motion of the door panel into or out of the pocket, and the change of the attachment of the pull-cable from the first to the second synchronization cable is not required.

In an embodiment of the pocket door of the invention, the drive means comprises a cable pulley driven by the power means to wind-up the pull-cable to the cable pulley.

In one aspect, one end of the pull-cable is fixed to the cable pulley, and the free end of the pull-cable is attached to the synchronization cable, such that the pull-cable exerts a pulling or drawing force on the synchronization cable to which it is attached when the pull-cable is wound-up onto the cable pulley by action of the power means, i. e. by the spring or electric motor. The pulling force of the pull-cable to one of the synchronization cables power-supports motion of the door panel in one direction, i. e., into or out of the pocket.

In an embodiment of the pocket door of the invention, the power means is a spring arranged and designed to rotate the cable pulley in a direction to wind-up the pull-cable onto the cable pulley under the force of the spring. By unwinding and pulling off the pull-cable from the cable pulley, the spring is loaded or biased, respectively. If the pulling force of the pull-cable to one of the synchronization cables power-supports motion of the door panel in one direction, i. e., into or out of the pocket, unwinding and pulling off the pull-cable from the cable pulley, and thereby re-loading and biasing of the spring, is effected by motion of the door panel in the opposite direction, which usually requires manual force by an operator or an additional power source, such as an electric motor, in addition to the force required for the motion of the door as such.

In another embodiment of the pocket door of the invention, the power means is an electric motor and the drive means comprises one cable pulley or two cable pulleys that are coupled to each other so that they rotate in the same direction or in opposite directions when one of the cable pulleys is rotated by the power means, and wherein the power support arrangement comprises two pull-cables, a first pull-cable and a second pull-cable, wherein the first and second pull-cables are connected to the one cable pulley or the first pull-cable is connected to one of the two cable pulleys and the second pull-cable is connected to the other one of the two cable pulleys in a manner that the second pull-cable is wound off the respective cable pulley when the first pull-cable is wound-up to the respective cable pulley, and vise versa, and wherein the first pull-cable is attached to one of the first or second synchronization cables and the second pull-cable is attached to the other one of the first or second synchronization cables.

In an aspect of this embodiment of the invention, the drive means comprises two cable pulleys and a first pull-cable and a second pull-cable, wherein the second pull-cable is fixed to the further cable pulley with the free end of the second pull-cable being attached to the other one of the first and second synchronization cables than the first pull-cable. This allows that each pull-cable exerts a pulling force for the motion of the door panel in opposite directions. In this case, the power means is preferably an electric motor, which allows to switch its direction of rotation and is arranged to rotate the two cable pulleys, at the same time. In an alternative two electric motors or one electric motor in combination with a spring may be used to rotate each of the cable pulleys separately.

One single electric motor may be utilized and arranged to rotate both cable pulleys in the same direction, e.g. if both cable pulleys share the same axis of rotation or are connected by a gear to effect rotation in the same direction. In this case, the pull-cables are arranged and fixed to the two cable pulleys in opposite orientations, such that one pull-cable is wound onto the cable pulley and the other one is wound off the cable pulley, when both cable pulleys are rotated in the same direction. In an alternative, one electric motor may be arranged to rotate both cable pulleys in opposite directions, e.g. by connecting the axes of rotation of the cable pulleys by a gear effecting rotation in opposite directions. In this case, the pull-cables are arranged and fixed to the two cable pulleys in the same orientations, such that one pull-cable is wound onto the cable pulley and the other one is wound off the cable pulley, when the cable pulleys are rotated in opposite directions.

In another alternative, each cable pulley is rotated by separate electric motors or one by an electric motor and one by spring force. Providing pulling forces for motion of the door panel in opposite directions only by spring force is not realized, since opposing spring forces would cancel each other out, and loading of one spring by the force of the other one, while at the same time providing power support for the motion of the door panel, is not possible.

In another embodiment of the invention, one single pull-cable may be attached with one end to the first synchronization cable and with the opposite end to the second synchronization cable, such that the pulling force of the pull-cable can provide power support for the door panel in both directions, i. e. for the motion of the door panel into and out of the pocket. In this aspect, one end of the pull-cable is not wound onto a cable pulley, but the pull-cable is rather arranged to be moved by the drive means about a deflection point or deflection roller in both directions, either in a direction to exert the pulling force on the first synchronization cable for the motion of the door panel in one of the directions into or out of the pocket, or in the opposite direction to exert the pulling force on the second synchronization cable for the motion of the door panel in the opposite direction. This embodiment preferably uses an electric motor as the power means, as it may be switched to drive a deflection roller in opposite directions. This embodiment requires that the torque by the rotation of the electric motor is transferred to the pull-cable to be moved about the deflection roller in one or the other direction without slipping to exert a pulling force to one of the synchronization cables and to freely move along with the other one of the synchronization cables to effect motion of the door panels in one or the other direction. Transfer of torque can be effected by using frictional force between the cable pulley surface and the pull-cable, e. g. by winding the pull-cable around the cable pulley several times, and/or by providing a pulley and/or cable surface that exerts high friction between the material. In an alternative, the pull-cable is a chain, a gear chain or a toothed wheel chain, and the cable-pulley is a gear wheel or toothed wheel.

In another embodiment of the invention, a motorized pulley, which can also be the pulley used to synchronize the movement of the carriages, is in direct contact with one of the synchronization cables and is fixed to the moving door or panel. This setup allows the door to move in either direction by changing the motor's direction of rotation. To ensure efficient operation, the amount of friction between the pulley and the cable must be optimized. This involves balancing sufficient friction to transmit the required force without slippage while minimizing friction to reduce wear and energy consumption.

The present invention offers numerous advantages. The power support arrangement of the invention can be retrofitted into an existing pocket door, usually without high effort. The invention empowers the user to effortlessly maneuver the door panel of the pocket door into and/out of the pocket. Adjustments to the speed, force, and distance of motion can be easily made by modifying the attachment point of the pull-cable to the respective synchronization cable and/or by selecting and configuring the power source. The versality of the present invention makes it suitable for both light-duty and heavy-duty pocket door applications, offering power support to manual operation as well as fully electrically motorized motion for added convenience.

The invention involves using the synchronization cables already present in a synchronized pocket door solution to move the door panel. The pull-cable may simply be clamped, cramped or hooked to the synchronization cable at almost any position or distance from the drive means.

The drive means may use spring power or electric motor power to effect a pull force of the pull-cable to the synchronization cables in vertical or essentially vertical direction, i. e. the direction of arrangement of the synchronization cables in the region between two deflection rollers. Thus, a vertically directed force is converted into a horizontal movement of the door panel.

The inventive solution enables the adjustment of the distance of the power support to pull the door into or out of the pocket by modifying or changing the distance or length of the pull-cable from the cable pulley to the point of attachment of the pull-cable to the synchronization cable. This adjustment can quickly be realized without high effort, since the attachment of the pull-cable to the synchronization cable may be by a clamping mechanism that is easy to open and refasten.

The inventive solution further provides either power support in both directions or allows to quickly change without high effort the direction of the power support, i. e. whether the system provides power support to pull the door into or out of the pocket. Using the clamping mechanism that is easy to open and refasten, this is very easily accomplished by simply removing the attachment of the pull-cable from the one synchronization cable to which it is hooked and attach it to the other one of the two synchronization cables, which then translates a pulling force of the pull-cable into a door movement in the opposite direction.

The inventive solution has the further advantage that it allows a door to be fully pulled out of the pocket or into the pocket to its end-position under power support, whereas known solutions may suffer from the disadvantage that power support may not be provided until the door reaches its end-position of the movement due to space constraints and limitations for the mounting of the holding members for hooking the pull-cable or positioning of the spring-forced cable pulley. Further constraints of the movement into or out of the pocket to the end-positions of the door may also arise from spring characteristics and changes of the spring force when the door approached the end position. With the inventive solution such constraints can be overcome by adjusting the distance or length of the pull-cable from the cable pulley to the hooking point of the pull-cable to the synchronization cable, such that an end-position of the door may be reached when the spring still has favorable spring characteristics.

According to the present invention, the pull-cable, e. g. in the form of a gear chain or a toothed wheel chain, may run about a gear wheel or toothed wheel driven by an electric motor and can be moved in two directions depending on and by changing the direction of rotation of the electric motor. One end of the pull-cable is attached to one of the two synchronization cables, and the other end of the pull-cable is attached to the other one of the two synchronization cables. Thereby, power support or full driving can be provided to the door panel in both directions, i. e. to pull the door into the pocket and out of the pocket. Sensors may be provided to sense a tip on the door in the direction into the pocket or to sense a slight pull out of the pocket to actuate the electric motor, i. e. to turn it on and of and to set the direction of rotation when turned on.

If power support is provided by spring force for the door to be pulled out of the pocket or into the pocket, it is advantageous to provide a hold-in or lock-in mechanism to arrest the door at the end-position, where the spring is in a loaded or tensioned state and primed to provide supply power to pull the door towards the opposite end-position. Otherwise, if nothing holds the pocket door at this end-position, it may unintentionally travel back again towards the opposite end due to the pulling force exerted by the power of the loaded or tensioned spring. Hold-in or lock-in mechanisms are generally known in the art, and may comprise manually, mechanically (non-electrically) or electrically actuated mechanisms or a combination thereof.

In embodiments of the present invention, the moving members or carriages are in engagement with the guide rails through ball bearings or roller bearing for the longitudinal motion along the guide rails. In one embodiment, such bearings are linear ball bearings or roller bearings with the balls or rollers moving (rolling) between two end stops of the linear raceway of the carriage. In another embodiment, such bearings are recirculating ball bearings or roller bearings with the balls or rollers being deflected into a return track inside the carriage when they reach the end of the raceway of the carriage and then being deflected again into the raceway of the carriage when they exit the return track at its opposite end. Such recirculating ball bearings or roller bearings are particularly suitable for high loads, i. e. for heavy pocket doors.

The term carriage herein is understood in a broad manner including any types of moving members suitable to be mounted on the door panel for engagement with the guide rails and suitable for suspension and longitudinal motion of the door panel along the guide rails.

### BRIEF DESCRIPTION OF THE DRAWINGS

Further advantages, features and possible applications of the present invention will become apparent from the following description of an embodiment according to the invention and the associated figures.

FIG. 1 shows a schematic side view of an embodiment of a pocket door according to the present invention.

FIG. 2 shows a schematic side view of an embodiment of a guide arrangement according to the present invention provided for the suspension and longitudinal motion of a door panel in a view onto the front side of the arrangement.

FIG. 3 shows a perspective presentation of the guide arrangement shown in FIG. 2 in a view onto the front side of the arrangement.

FIG. 4 shows a perspective presentation of the guide arrangement shown in FIG. 2 in a view onto the back side of the arrangement.

FIG. 5 shows the upper part of the guide arrangement shown in FIG. 2 schematic side view of the guide arrangement shown in FIG. 2 with an enlarged view (circle) of the clamp mechanism for fastening the pull-cable to one of the synchronization cables.

### DETAILED DESCRIPTION OF EMBODIMENTS

The figures show different representations of an embodiment of a pocket door of the present invention and a guide arrangement provided for the suspension and longitudinal motion of the door panel.

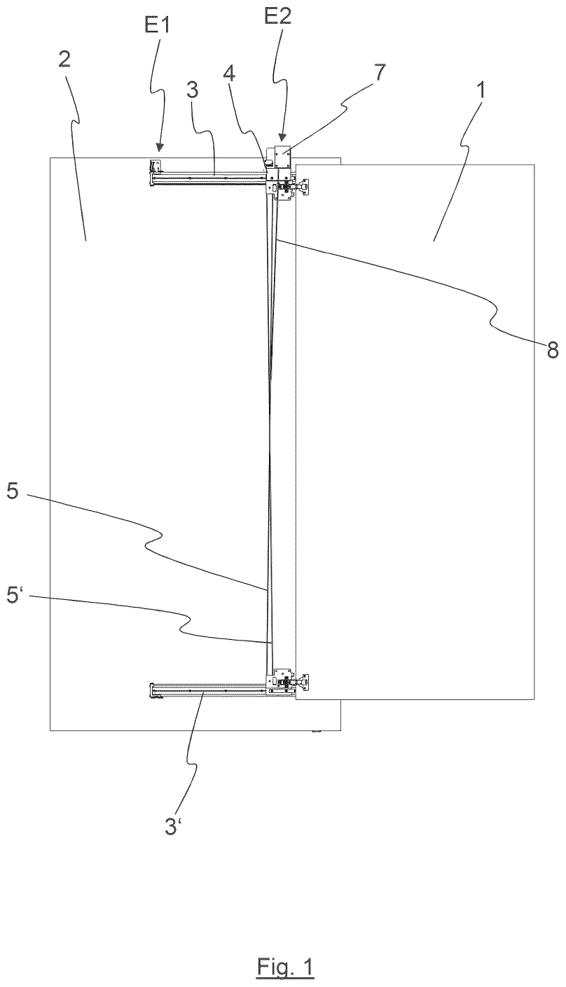

As shown in FIG. 1, a pocket door of the present invention comprises a door panel 1 and a guide arrangement provided for the suspension and longitudinal motion of the door panel 1.

The guide arrangement comprises an upper guide rail 3 and a lower guide rail 3′, each being mounted to a wall or a panel of a pocket or compartment at different vertical heights.

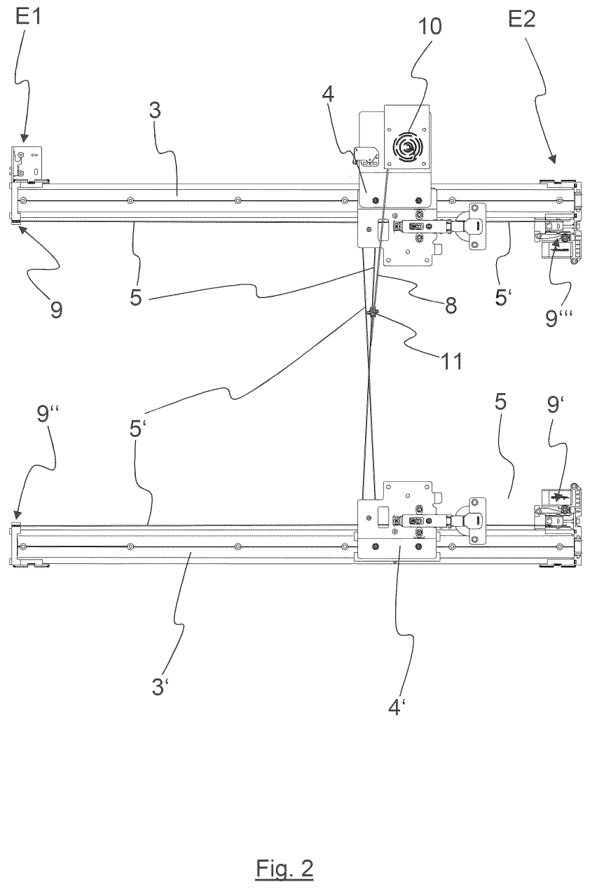

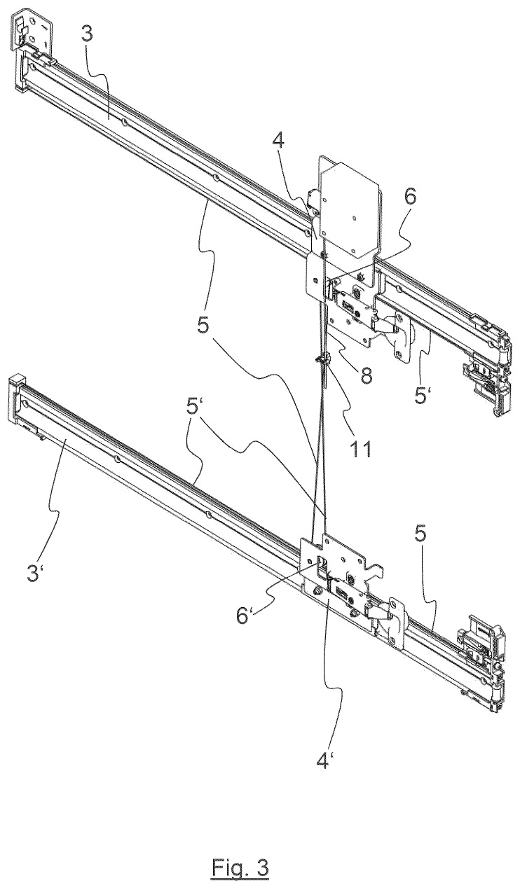

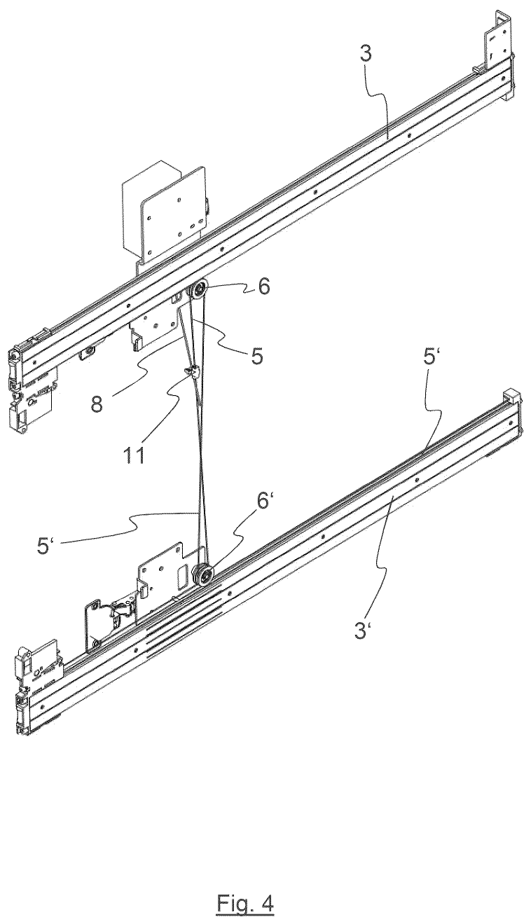

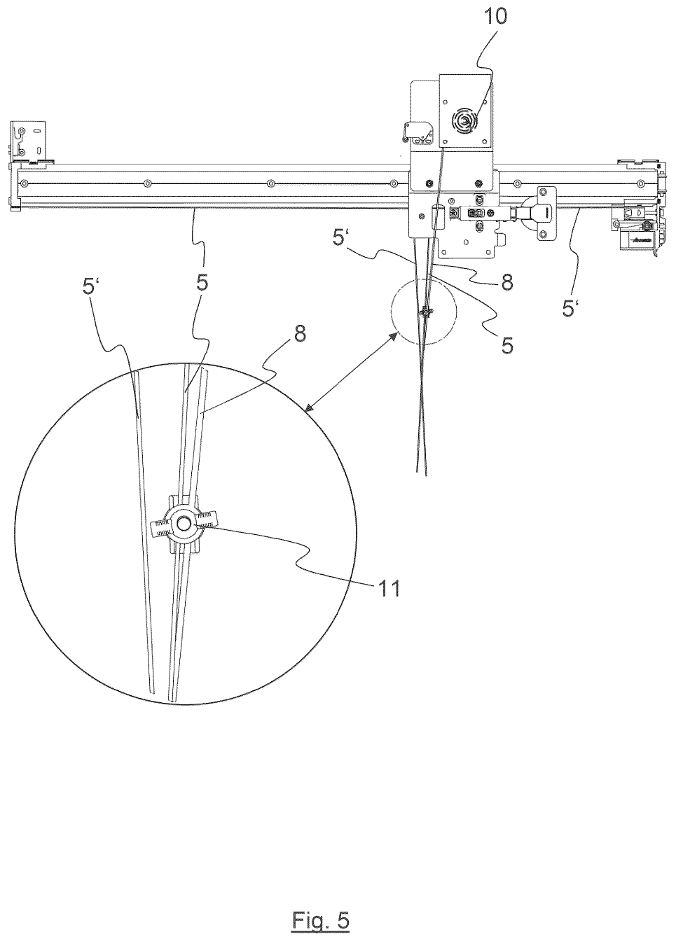

FIGS. 2 to 5 show different representations and views of the guide arrangement of the pocket door of the present invention, whereby for presentation reasons the distance between the upper guide rail 3 and the lower guide rail 3′ is not necessarily true to scale compared to the representation of FIG. 1.

The guide arrangement comprises an upper carriage 4 and a lower carriage 4′ being mounted in a fixed connection on the door panel 1 at different vertical heights for engagement with the upper and lower guide rails 3 and 3′ and being designed and provided for suspension and longitudinal motion of the door panel 1 along the upper and lower guide rails 3 and 3′ between a retracted end disposition E1 and an extended end position E2.

The synchronization system for the synchronization of the motion of the upper and lower carriages 4 and 4′ along the guide rails 3 and 3′ comprises first and second synchronization cables 5 and 5′ and at least two deflection rollers 6 and 6′, an upper deflection roller 6 mounted in a fixed connection to the upper carriage 4 and a lower deflection roller 6′ mounted in a fixed connection to the lower carriage 4′.

The first synchronization cable 5 extends from a hooking point 9, which is located at the upper guide rail 3 at or beyond the retracted end position E1 with respect to the direction of motion from the extended end position E2 to the retracted end position E1, to the upper deflection roller 6, which is in a fixed connection with the upper carriage 4, is then deflected at the deflection roller 6 and extends further to the lower deflection roller 6′, which is in a fixed connection with the lower carriage 4′, is then deflected at the deflection roller 6′ and extends further to a hooking point 9′, which is located at the lower guide rail 3′ at or beyond the extended end position E2 with respect to the direction of motion from the retracted end position E1 to the extended end position E2.

The second synchronization cable 5′ extends from a hooking point 9″, which is located at the lower guide rail 3′ at or beyond the retracted end position E1 with respect to the direction of motion from the extended end position E2 to the retracted end position E1, to the lower deflection roller 6′, which is in a fixed connection with the lower carriage 4′, is then deflected at the deflection roller 6′ and extends further to the upper deflection roller 6, which is in a fixed connection with the upper carriage 4, is then deflected at the deflection roller 6 and extends further to a hooking point 9″, which is located at the upper guide rail 3 at or beyond the extended end position E2 with respect to the direction of motion from the retracted end position E1 to the extended end position E2.

The power support arrangement 7 for supporting or effecting the motion of the pocket door 1 is arranged in a fixed connection with the upper carriage 4. The power support arrangement 7 comprises a cable pulley 10 arranged in a housing and driven by drive means to wind up a pull-cable 8. The free or lose end of the pull-cable 8 distant from the cable pulley 10 is attached or fastened to one of the first or second synchronization cables. In the representations shown in the figures, the pull-cable 8 is attached to the first synchronization cable 5 by a clamp 11. In this embodiment, an upwardly directed pulling force transferred by the pull-cable 8 to the first synchronization cable 5, to which it is attached or fastened through the clamp 11, results in a motion of the carriages 4 and 4′ and the door panel 1 mounted thereon towards the extended end position E2 out of the pocket. To effect a power supported motion of the carriages and the door panel towards the opposite direction, i. e. towards the retracted end position E1, the attachment of the pull-cable 8 to the first synchronization cable 5 through the clamp 11 can easily be disconnected and attached to the second synchronization cable 5′.

As outlined above, the invention includes many variants of the drive means to exert a pulling force on the pull-cable 8, including an electric motor instead of a spring, and/or a variety of arrangements to wind up or move the pull-cable 8, including those wherein the pull-cable 8 may be attached to both of the first and second synchronization cables 5 and 5′ and an electric motor as the power means to allow for a power support in both directions of motion of the door panel 1, i.e. towards the retracted end position E1 and the extended end position E2 by switching the direction of rotation of the electric motor.

For the purposes of the original disclosure, it is pointed out that all features, as they appear to a person skilled in the art from the present description, the drawings and the claims, even if they have been described specifically only in connection with certain specific further features, can be combined both individually and in any combination with other features or groups of features disclosed here, unless this has been expressly excluded or technical circumstances make such combinations impossible or pointless. A comprehensive, explicit description of all conceivable combinations of features is omitted here only for the sake of brevity and readability of the description.

While the invention has been illustrated and described in detail in the drawings and the foregoing description, this description of the invention is given by way of example only and is not intended to limit the scope of protection as defined by the claims. The invention is not limited to the embodiments shown.

Variations of the disclosed embodiments will be obvious to those skilled in the art from the drawings, the description and the appended claims. In the claims, the word “comprising” does not exclude other elements or steps, and the indefinite article “a” does not exclude a plurality. The mere fact that certain features are claimed in different claims does not exclude their combination. Reference signs in the claims are not intended to limit the scope of protection.

### REFERENCE LIST

1 door panel
2 pocket wall
3 upper guide rail
3′ lower guide rail
4 upper carriage
4′ lower carriage
5 first synchronization cable
5′ second synchronization cable
6 upper deflection roller
6′ lower deflection roller
7 power support arrangement
8 pull-cable
9, 9′, 9″, 9″ hooking points of synchronization cables
10 cable pulley
11 clamp

1. A pocket door comprising:
a door panel and
a guide arrangement provided for the suspension and longitudinal motion of the door panel, wherein the guide arrangement comprises:
an upper guide rail and a lower guide rail, each being mounted or provided to be mounted to a wall or panel of a pocket or compartment at different vertical heights,
an upper carriage and a lower carriage being mounted in a fixed connection on the door panel at different vertical heights for engagement with the upper and lower guide rails and being designed and provided for suspension and longitudinal motion of the door panel along the upper and lower guide rails-between a retracted end-position and an extended end-position,
a synchronization system for the synchronization of the motion of the upper and lower carriages along the guide rails, the synchronization system comprising:
first and second synchronization cables and
at least two deflection rollers being mounted in a fixed connection to the upper and lower carriages,
wherein the first synchronization cable extends from a first hooking point, which is located at or beyond the retracted end-position with respect to the direction of motion from the extended end position to the retracted end position, to a first of the deflection rollers, which is in a fixed connection with the upper carriage, is then deflected at the first of the deflection rollers and extends further to a second of the deflection rollers, which is in a fixed connection with the lower carriage, is then deflected at the second of the deflection rollers and extends further to a second hooking point, which is at or beyond the extended end-position with respect to the direction of motion from the retracted end position to the extended end position, and
wherein the second synchronization cable extends from a third hooking point, which is located at or beyond the retracted end-position with respect to the direction of motion from the extended end position to the retracted end position, to the second of the deflection rollers or to a third deflection roller, which is in a fixed connection with the lower carriage, is then deflected at the second of the deflection rollers or at the third deflection roller and extends further to the first of the another deflection rollers or to a fourth deflection roller, which is in a fixed connection with the upper carriage, is then deflected at the first of the deflection rollers or at the fourth deflection roller and extends further to a fourth hooking point, which is at or beyond the extended end-position with respect to the direction of motion from the retracted end position to the extended end position,
a power support arrangement for supporting or affecting the motion of the pocket door comprising:
a pull-cable attached to one of the first or second synchronization cables and
a drive means exerting a pulling force on the pull-cable, wherein the drive means comprises a power means selected from a spring and an electric motor.

2. The pocket door of claim 1, wherein the pull-cable is attached to at least the first or second synchronization cable by a clamp or hook at a distance from the drive means in a region of the respective first or second synchronization cable extending between the first of the deflection rollers or the third deflection roller and the second of the deflection rollers or the fourth deflection roller.

3. The pocket door of claim 1, wherein the drive means comprises a cable pulley driven by the power means to wind-up the pull-cable to the cable pulley.

4. The pocket door of claim 3, wherein the power means is a spring arranged and designed to rotate the cable pulley in a direction to wind-up the pull-cable to a cable pulley, wherein the spring is loaded or biased by unwinding and pulling off the pull-cable from the cable pulley.

5. The pocket door of claim 1,
wherein the power means is an electric motor and the drive means comprises one cable pulley or two cable pulleys that are coupled to each other so that they rotate in the same direction or in opposite directions when one of the cable pulleys is rotated by the the power means,
wherein the power support arrangement comprises the pull-cable and a second pull-cable, wherein the pull-cable and the second pull-cable are connected to the one cable pulley or the pull-cable is connected to one of the two cable pulleys and the second pull-cable is connected to the other one of the two cable pulleys in a manner that the second pull-cable is wound off the respective cable pulley when the first pull-cable is wound-up to the respective cable pulley, and vise versa, and
wherein the pull-cable is attached to one of the first or second synchronization cables and the second pull-cable is attached to the other one of the first or second synchronization cables.

6. The pocket door of claim 1, wherein the pull-cable is in the form of a wire, strand or cable braided or twisted from several filaments, a chain, a gear chain, or a toothed wheel chain.

7. The pocket door of claim 1, wherein the upper and lower carriages are mounted on the door panel in vertical alignment to each other.

8. The pocket door of claim 1, wherein the upper and lower guide rails are mounted to the wall or panel of the pocket or compartment in vertical alignment to each other.
